(19) United States
(12) Patent Application Publication
(10) Pub. No.: US 2023/0026664 A1
(43) Pub. Date: Jan. 26, 2023

(54) ACCESS FILTER FOR BIOS VARIABLES

(71) Applicant: HEWLETT-PACKARD DEVELOPMENT COMPANY, L.P., SPRING, TX (US)

(72) Inventors: RICHARD CATENA, LAWRENCEVILLE, NJ (US); RICHARD ALDEN BRAMLEY, Jr., MANSFIELD, MA (US); JEFFREY KEVIN JEANSONNE, SPRING, TX (US)

(21) Appl. No.: 17/758,173

(22) PCT Filed: Jan. 31, 2020
(86) PCT No.: PCT/US2020/016219

§ 371 Date: Jun. 29, 2022

(51) Int. Cl. G06F 21/57; G06F 21/56

(52) U.S. Cl. CPC G06F 21/577; G06F 21/566

(57) ABSTRACT

An example computing device includes: a storage device; a first controller to retrieve basic input/output system (BIOS) instructions, including a set of filter criteria, from the storage device, and execute the BIOS instructions to: detect a command to change a set of BIOS variables associated with the BIOS instructions; store the command in a log; compare a payload of the command with the set of filter criteria; and accept or reject the change to the set of BIOS variables according to the comparison.

### BACKGROUND

Computing devices may include a basic input/output system (BIOS). When a computing device is booted, the BIOS may be executed to initialize hardware components of the computing device, and initiate execution of processes such as an operating system (OS) and/or other applications by the computing device. The initialization of hardware components and execution of processes may be based on BIOS variables stored in association with the BIOS itself. The BIOS variables may be altered in order to alter the initialization of hardware and processes when the computing device is booted.

### BRIEF DESCRIPTIONS OF THE DRAWINGS

FIG. 1 is a block diagram of an example computing device with a set of filter criteria for acceptance or rejection of BIOS variable updates.

FIG. 2 is a flowchart of an example method of filtering access to BIOS variables in a computing device.

FIG. 3 is a block diagram of an example computing device with distinct storage devices for BIOS instructions and a log, that applies a set of filter criteria for acceptance or rejection of BIOS variable updates.

FIG. 4 is a block diagram of an example computing device with storage devices for BIOS instructions, a log, and a scanning application, that applies a set of filter criteria for acceptance or rejection of BIOS variable updates, and scans logged BIOS variable updates for malicious content.

FIG. 5 is a flowchart of an example method of filtering access to BIOS variables and scanning BIOS variable change commands for malicious content in a computing device.

### DETAILED DESCRIPTION

A BIOS of a computing device initializes hardware components of the computing device, as well as boot processes to load an OS or other applications. The BIOS performs such initialization based on BIOS variables stored in association with the BIOS. The BIOS variables may be modified by various mechanisms, including application programming interface (API) calls from the OS executed by the computing device.

Malicious applications executed by the computing device may attempt to modify the BIOS variables, for example to harden malicious processes against removal. Such malicious modifications to the BIOS variables may be prevented by use of a set of filter criteria within the BIOS. Commands to modify the BIOS variables, such as a command to create a new BIOS variable, may be stored in a log for subsequent inspection.

The commands may be compared to the set of filter criteria via execution of the BIOS. The modifications may be accepted or rejected according to the comparison. In some examples, the above-mentioned log may be accessed by a scanning application executed by the computing device. The scanning application may therefore expose the logged BIOS variable modification commands to additional detection functionality beyond that provided by the set of filter criteria within the BIOS.

As used herein, BIOS refers to hardware or hardware and instructions to initialize, control, or operate a computing device prior to execution of an OS of the computing device. Instructions included within a BIOS may be software, firmware, microcode, or other programming that defines or controls functionality or operation of a BIOS. In one example, a BIOS may be implemented using instructions, such as platform firmware of a computing device, executable by a processor. A BIOS may operate or execute prior to the execution of the OS of a computing device. A BIOS may initialize, control, or operate components such as hardware components of a computing device and may load or boot the OS of computing device.

In some examples, a BIOS may provide or establish an interface between hardware devices or platform firmware of the computing device and an OS of the computing device, via which the OS of the computing device may control or operate hardware devices or platform firmware of the computing device. In some examples, a BIOS may implement the Unified Extensible Firmware Interface (UEFI) specification or another specification or standard for initializing, controlling, or operating a computing device.

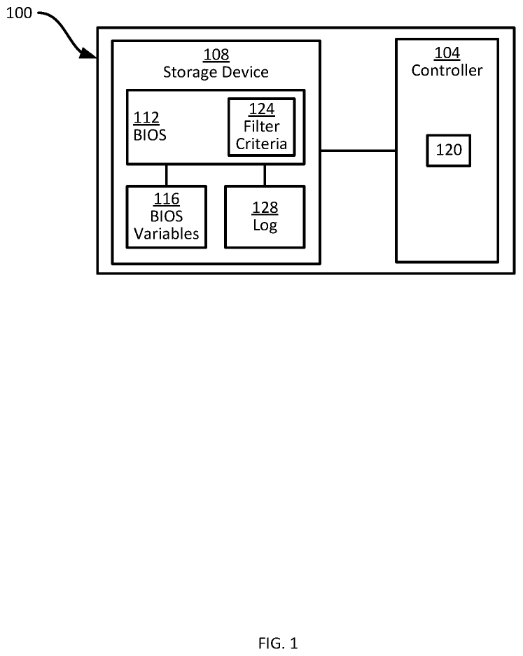

FIG. 1 shows an example computing device 100. The computing device 100 may be a desktop computer, a server, a smartphone, a notebook computer, a tablet computer, or similar device. The computing device 100 includes a controller 104, which may also be referred to as a processor. The computing device 100 also includes a non-transitory computer-readable medium such as a storage device 108, which may also be referred to as a memory, coupled to the controller 104. The computing device 100 may include other components not illustrated for sake of clarity, such as a power supply, output device (e.g. a display), input device (e.g. a keyboard), and the like.

The storage device 108 contains BIOS instructions 112, also referred to herein as the BIOS 112, that are executable by the controller 104. The BIOS 112 includes instructions executable by the controller 104 to initiate hardware devices of the computing device 100, and to initiate execution of other sets of instructions contained in the storage device 108. An example of such other instructions include an OS of the computing device 100.

The initiation of hardware devices and execution of other sets of instructions may be performed with reference to a set of BIOS variables 116 contained in the storage device 108 in association with the BIOS 112. An example of variables defined in the BIOS variables 116 include a boot order, defining portions of the storage device 108 or other storage devices from which the controller 104 is to attempt to retrieve OS instructions. Other examples of variables defined in the BIOS variables 116 include identifiers of device drivers to be loaded when the computing device 100 boots. Further examples of variables defined in the BIOS variables 116 include secure boot databases containing encryption keys, signatures and the like.

The BIOS variables 116 may be updated, for example to edit or delete an existing BIOS variable, or to create a new BIOS variable. The controller 104 may generate a command 120 to change the BIOS variables 116. The command 120 may be generated, for example, via the execution of another application by the controller 104, and/or in response to input data received via an input device of the computing device 100.

The BIOS instructions 112 also include a set of filter criteria 124. Via execution of the BIOS 112, the controller 104 is to perform certain functions prior to applying the change to the BIOS variables 116 defined in the command 120. For example, the controller 104 may store the command, or a portion thereof, in a log 128 stored in the storage device 108. The controller 104 may also compare the command with the set of filter criteria 124. The set of filter criteria 124 define a condition, or a plurality of conditions, against which the command 120 may be evaluated.

The set of filter criteria 124 may be employed to detect potentially malicious changes to the BIOS variables 116. Therefore, when the command 120 satisfies the set of filter criteria 124, the controller 104 may reject the change to the BIOS variables 116 defined by the command 120. When the command 120 does not satisfy the set of filter criteria 124, however, the controller 104 may accept the change to the BIOS variables 116 defined by the command 120. In other examples, the set of filter criteria 124 may define conditions met by non-malicious changes to the BIOS variables 116, and the controller 104 may therefore reject changes to the BIOS variables 116 that do not meet the set of filter criteria 124 and accept changes to the BIOS variables 116 that meet the set of filter criteria 124.

The set of filter criteria 124 may define various conditions to which the command 120 is compared by the controller 104. An example of a condition defined by the set of filter criteria 124 is a command frequency threshold defining a permissible frequency of changes to the BIOS variables 116. The frequency may be defined according to any suitable time period, e.g. a permissible number of commands 120 per day, or the like. For example, for a frequency threshold of five permissible commands per day, when the command 120 represents the sixth command to change the BIOS variables 116 within a one-day period, the command 120 may be rejected. When the command 120 is rejected, the change to the BIOS variables 116 defined by a payload of the command 120 is not applied to the BIOS variables 116. The command 120 may still be stored in the log 128, however.

Another example condition defined by the set of filter criteria 124 is a payload size threshold. For example, the set of filter criteria 124 may define an upper permissible BIOS variable size threshold, and the controller 104 may reject the command 120 when the command 120 defines a new or updated variable with a size greater than the size threshold.

Additional example conditions defined by the set of filter criteria 124 include a whitelisted variable owner identifier, a blacklisted variable owner identifier, or a combination thereof. Each variable in the BIOS variables 116 may include an owner identifier, a variable name, and a variable value. The owner identifier of a given BIOS variable may indicate the identity of an entity responsible for the current value of the BIOS variable. An examples owner identifier includes an identifier of a manufacturer of the computing device 100. The set of filter criteria 124 may define conditions specifying owner identifiers that are permitted to write to the BIOS variables 116 (e.g. a whitelist). The set of filter criteria 124 may also define conditions specifying owner identifiers that are not permitted to write to the BIOS variables 116 (e.g. a blacklist).

The set of filter criteria 124 may include combinations of the example conditions mentioned above.

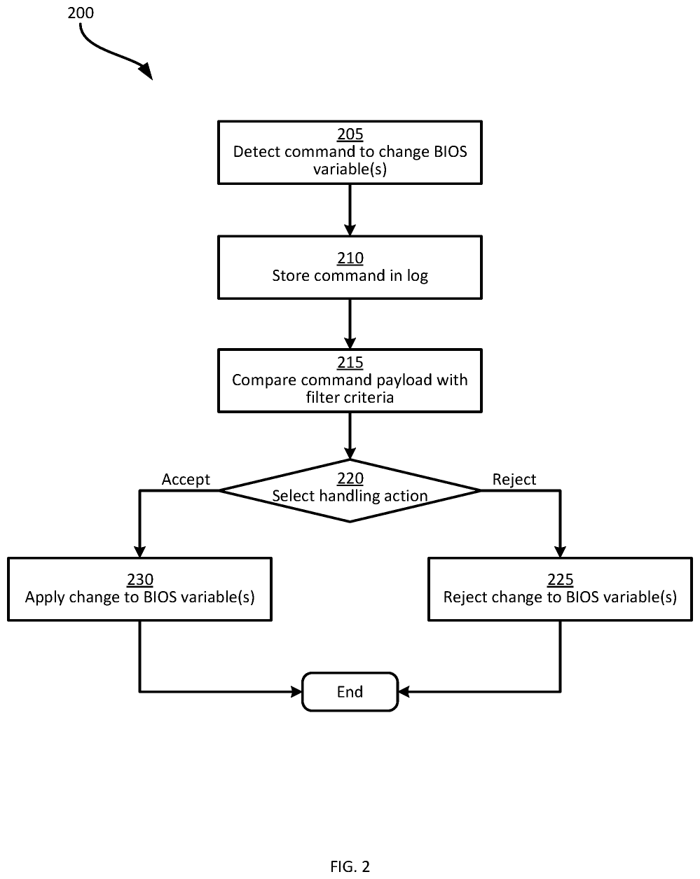

FIG. 2 shows an example method 200 of filtering access to BIOS variables. The method 200 may be embodied by a set of instructions (e.g. the BIOS instructions 112 shown in FIG. 1) that may be stored in a non-transitory computer-readable medium and executed by a controller. The method 200 is described below in conjunction with an example performance of the method 200 by the computing device 100.

At block 205, a command to change the BIOS variables 116, such as the command 120, is detected by the controller 104, via execution of the BIOS 112. The command 120 detected at block 205 may be generated by the controller 104 via the execution of an application. The application may, in some instances, be a malicious application.

At block 210, the command 120 is stored in the log 128. The entire command 120 may be stored in the log 128 at block 210. In other examples, a portion of the command 120 may be stored in the log 128 at block 210. At block 210 the controller 104 may also store metadata associated with the command 120 in the log 128, such as a date and/or time of detection of the command 120, an indication of an application whose execution led to generation of the command 120, and the like.

At block 215, the controller 104 compares a payload of the command 120 with the set of filter criteria 124. The payload of the command includes the owner identifier, the variable name and the variable value to be written to the BIOS variables 116. When the set of filter criteria 124 define a plurality of conditions, each condition may be evaluated at block 215 in comparison to the corresponding portion of the command payload. For example, the owner identifier in the command payload may be compared to a whitelist defined in the set of filter criteria 124, and a size of the value defined in the command 120 may be compared to a size threshold defined in the set of filter criteria 124.

At block 220, the controller 104 selects a handling action for the command 120, according to the comparison from block 215. As noted earlier, the controller 104 is to accept or reject the change defined in the command 120 according to whether the command 120 satisfies, or does not satisfy, the set of filter criteria 124. In the above example, in which the set of filter criteria 124 define a variable owner whitelist and a variable size threshold, at block 220 the controller 104 may select the rejection handling action if the variable size in the command 120 exceeds the threshold, or if the variable owner identifier is not on the whitelist, or both. If the variable owner identifier in the command 120 is on the whitelist and the size of the value in the command 120 is below the threshold, the controller 104 may select the acceptance handling action.

When the controller 104 selects the rejection handling action, performance of the method 200 proceeds to block 225. At block 225, the controller 104 may reject the change to the BIOS variables 116 defined by the command 120. As a result of the performance of block 225, the BIOS variables 116 remain unchanged, and performance of the method 200 may end.

When the controller 104 selects the acceptance handling action, performance of the method 200 proceeds to block 230. At block 230, the controller 104 may accept the change to the BIOS variables 116 defined by the command 120. As a result of the performance of block 230, the BIOS variables 116 are therefore updated to include a newly created variable, an edited variable, to omit a deleted variable, or a combination thereof. Performance of the method 200 may then end.

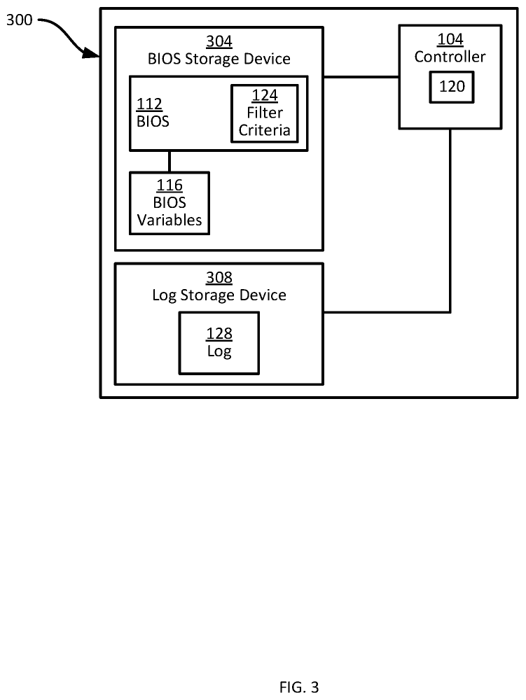

Turning to FIG. 3, an example computing device 300 is illustrated. In addition to the controller 104 having generated and/or detected the command 120, the computing device 100 includes a BIOS storage device 304 and a log storage device 308. The BIOS storage device 304 and the log storage device 308 are connected to the controller 104, and together provide an example implementation of the storage device 108 shown in FIG. 1. The BIOS storage device 304 may include, for example, a read-only memory (ROM) storing the BIOS instructions 112 and the set of filter criteria 124. The BIOS storage device 304 may also include a storage device such as a non-volatile random access memory (NVRAM) containing the BIOS variables 116. The log storage device 308 can be implemented as an NVRAM device, or as another suitable storage device (e.g. flash memory or the like).

The computing device 300 may, in response to detection of the command 120, compare the command 120 to the set of filter criteria 124 and accept or reject changes to the BIOS variables 116 via communication with the BIOS storage device 304. The controller 104 may also communicate with the log storage device 308 to store the command 120 in the log 128.

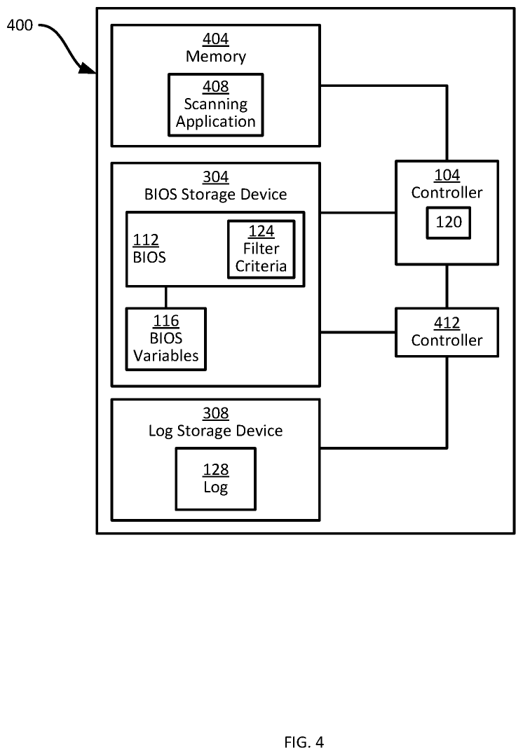

Referring to FIG. 4, an example computing device 400 is illustrated. In the computing device 400, the previously-mentioned storage device 108 is implemented as the BIOS storage device 304 and log storage device 308 as shown in FIG. 3, in combination with a memory 404. The memory 404 may include a volatile memory device such as a random access memory (RAM), a non-volatile memory device such as a hard drive, flash memory or the like, or a combination of volatile and non-volatile memory devices. The memory 404 may store sets of instructions defining executable applications, including a scanning application 408.

The computing device 400 also includes a second controller 412. The second controller 412 may implement BIOS security functions, such as BIOS validation to determine whether the BIOS instructions 112 have been tampered with. The second controller 412 may therefore also be referred to as an embedded security controller 412. The second controller 412 may, when such tampering is detected, refresh the BIOS instructions 112 from a backup copy stored within the second controller 412.

In the computing device 400, the controller 104 may also be referred to as the first controller 104. While the first controller 104 may execute the instructions in the BIOS storage device 304 (e.g. the BIOS 112) and the memory 404 (e.g. the scanning application 408), the first controller 104 may not have direct access to the log storage device 308. Instead, the second controller 412 is connected with the log storage device 308.

To store the command 120 in the log 128, e.g. as described in connection with block 210 of the method 200, the controller 104 may pass the command 120 to the second controller 412. The second controller 412 may then store the command 120 in the log 128. The first controller 104 may also execute the instructions of the scanning application 408 to scan files, executable instructions and the like in the memory 404 for malicious content. The first controller 104 can also obtain logged commands, such as the command 120, from the log storage device 308 in order to scan the logged commands for malicious content.

In the example shown in FIG. 4, to obtain a logged command, such as the command 120, from the log 128, the first controller 104 is to transmit a request to the second controller 412 for a portion of the log 128. The portion of the log 128 can be up to the entire log 128, or can be restricted by a date range, a command type range (e.g. only commands for creating new BIOS variables), or the like. In response to the request, the second controller 412 may retrieve relevant commands from the log 128 and provide the retrieved commands to the first controller 104. The first controller 104 may then process the commands, for example by scanning the commands for malicious content via execution of the scanning application 408.

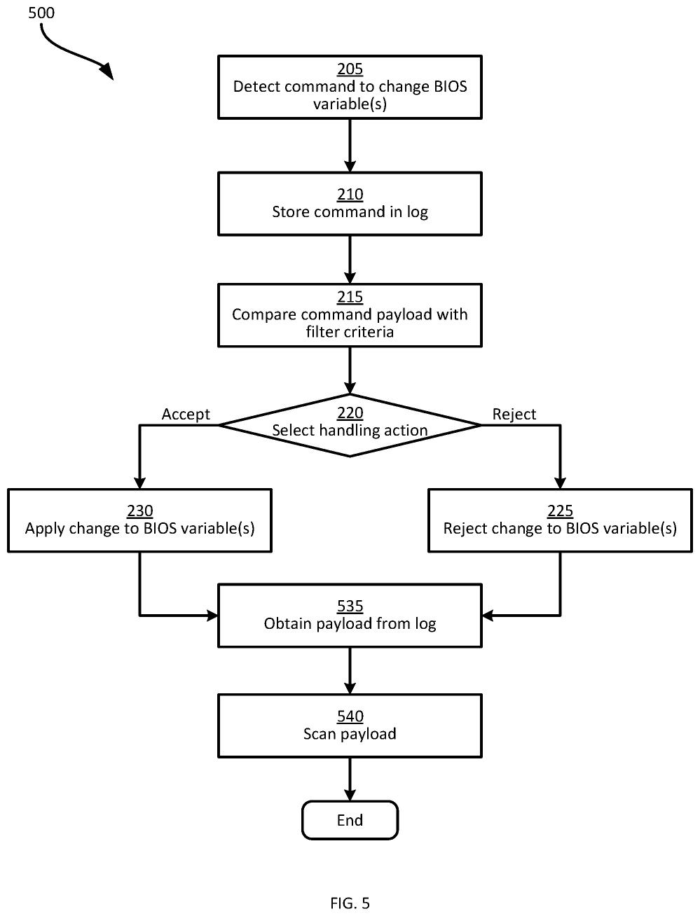

FIG. 5 shows an example method 500 of filtering access to BIOS variables. The method 500 may be embodied by a set of instructions (e.g. the BIOS instructions 112 shown in FIG. 1) that may be stored in a non-transitory computer-readable medium and executed by a controller. The method 500 is described below in conjunction with an example performance of the method 500 by the computing device 400.

The performance of blocks 205, 210, 215, 220, 225 and 230 in the method 500 is as described above in connection with the method 200. Following the performance of block 225 or 230, at block 535 the controller 104 may execute the scanning application 408 to obtain a command payload from the log 128. As noted above, the first controller 104 can obtain the command payload from the log 128 by requesting a portion of the log 128 from the second controller 412. In other examples, such as the computing device 300 shown in FIG. 3, the controller 104 may retrieve the log directly from the log storage device 308, omitting intermediation by the second controller 412.

At block 540, the controller 104 may scan the retrieved command(s) for malicious content via execution of the scanning application 408. Scanning the retrieved command(s) may include comparing the commands, e.g. the payload of a command, to a predefined list of previously detected malicious payloads. The controller 104 may also, e.g. via execution of the scanning application 408, transmit the contents of the log 128 to another computing device such as a centralized monitoring server to collect logs from a plurality of computing devices. Such a monitoring server may update malicious payload definitions for use by the scanning application 408 and transmit the updated definitions to the computing device 100 for use in subsequent scans. The monitoring server may also provide the computing device 100 with updated blacklisted and/or whitelisted variable owner identifiers, to update the set of filter criteria 124.

It should be recognized that features and aspects of the various examples provided above can be combined into further examples that also fall within the scope of the present disclosure. In addition, the figures are not to scale and may have size and shape exaggerated for illustrative purposes.

1. A computing device, comprising:
a storage device;
a first controller to retrieve basic input/output system (BIOS) instructions, including a set of filter criteria, from the storage device, and execute the BIOS instructions to:
detect a command to change a set of BIOS variables associated with the BIOS instructions;
store the command in a log;
compare a payload of the command with the set of filter criteria; and
accept or reject the change to the set of BIOS variables according to the comparison.

2. The computing device of claim 1, wherein the set of filter criteria includes a command frequency threshold, a payload size threshold, a whitelisted variable owner identifier, a blacklisted variable owner identifier, or a combination of such.

3. The computing device of claim 1, wherein the storage device includes a BIOS storage device containing the BIOS instructions, and a log storage device containing the log.

4. The computing device of claim 3, further comprising a second controller associated with the log storage device; wherein the first controller is to pass the command to the second controller for storage in the log.

5. The computing device of claim 4, wherein the first controller is to pass a result of the comparison to the second controller for storage in the log.

6. The computing device of claim 1, wherein the command includes a command to create a new BIOS variable for storage with the set of BIOS variables.

7. The computing device of claim 1, the first controller to generate the command via execution of an application, prior to detection of the command.

8. The computing device of claim 1, the first controller to execute a scanning application to:
retrieve the command from the log; and
scan the command for malicious content.

9. A computing device, comprising:
a basic input/output system (BIOS) storage device to store BIOS instructions including a set of filter criteria;
a log storage device; and
a first controller to retrieve the BIOS instructions from the BIOS storage device, and execute the BIOS instructions to:
receive a command to change a BIOS variable associated with the BIOS instructions;
log the command in the log storage device;
compare the command with the set of filter criteria;
select a command handling action according to the comparison; and
execute the command handling action.

10. The computing device of claim 9, further comprising:
a second controller connected with the log storage device;
wherein the first controller is, to log the command, to transmit a payload of the command to the second controller; and
wherein the second controller is to store the payload in the log storage device.

11. The computing device of claim 10, wherein the first controller is to execute a scanning application to:
obtain the payload from the log storage device; and
scan the payload for malicious content.

12. The computing device of claim 9, wherein when the command satisfies the set of filter criteria, the first controller is to select a rejection command handling action; and
wherein the first controller is, in order to execute the rejection command handling action, to reject the command to change the BIOS variable.

13. A non-transitory computer-readable medium having a set of instructions executable by a controller to:
obtain a command defining a basic input/output system (BIOS) variable update to change a set of BIOS variables associated with the set of instructions;
store the BIOS variable update in a log;
compare the BIOS variable updated with a set of filter criteria defined in the set of instructions; and
accept or reject the change to the set of BIOS variables according to the comparison.

14. The non-transitory computer-readable medium of claim 13, wherein the set of filter criteria includes a command frequency threshold, a payload size threshold, a whitelisted variable owner identifier, a blacklisted variable owner identifier, or a combination of such.

15. The non-transitory computer-readable medium of claim 13, wherein the set of instructions is executable by the controller to:
retrieve the command from the log; and
scan the command for malicious content.
